(19) United States
(12) Patent Application Publication
(10) Pub. No.: US 2008/0227188 A1
(43) Pub. Date: Sep. 18, 2008

(54) Biosensor with Optically Matched Substrate

(75) Inventors: Reinhold Wimberger-Friedl, Eindhoven (NL); Marcus Antonius Verschuuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/088,941

(22) PCT Filed: Sep. 25, 2006
(86) PCT No.: PCT/IB2006/053465

§ 371 Date: Apr. 2, 2008

(30) Foreign Application Priority Data
Oct. 3, 2005 (EP) 05109135.3

(51) Int. Cl. G01N 21/05

(52) U.S. Cl. 435/288.7

(57) ABSTRACT

The matching of refractive index of a nanoporous membrane with an analyte solution used with the membrane for use in a sensor is described. Scattering of the excitation and/or emitted light is reduced by matching the refractive indices. This improves efficiency when the porous translucent membrane is used in flow-through or flow-over sensors such as biosensors.

The present invention relates to sensors, especially chemical, biochemical, or biosensors as well as methods of making and operating the same. The biosensors may be used in particular for clinical diagnostic applications, like diagnosis of infectious diseases, as well as for monitoring food quality, environmental parameters, etc.

Sensitivity is of vital importance to any biosensing device. Optical detection via fluorescence or chemiluminescence has usually been used. Typically glass or amorphous polymer substrates are used with immobilized capture probes attached to the surface via particular coupling chemistry. The biological binding is measured via the intensity of the light generated by labels which become bound to the binding sites on the surface. The emitted light is propagating in all directions and only part of it can be projected onto a sensor surface. As a consequence of the proximity of the substrate a large portion of the light is coupled into the substrate and cannot reach the sensor on top or bottom thereof independent of whether the sensor is used in reflective or transmissive mode. Structured surfaces on non-porous substrates have been proposed in order to improve the light outcoupling.

The binding kinetics towards surfaces is limited due to diffusion limitation in laminar flow (Nernst boundary layer). This slows down the rate of binding and signal rise and consequently, since equilibrium is usually not awaited, also the sensitivity of the measurement. To overcome this limitation flow-through arrangements have been developed in which the capture probes are attached to microscopic channel walls perpendicular to the substrate plane. The analyte flows through the pores. Due to the tiny dimensions diffusion limitation is avoided. Also the specific surface area is increased dramatically so that more labels can get immobilized per projected area to increase the signal (see for example U.S. Pat. No. 6,635,493, U.S. Pat. No. 6,383,748). The outcoupling of the light, however, is affected by the heterogeneous structures.

As an alternative to the anisotropic pore structures in these known designs, random structures as present in filter membranes can be used for such a flow-through device. The capture probes and consequently the immobilized labels are distributed in the thickness direction of the membrane. The generated light has to pass through the scattering medium to reach the sensor surface. This process is rather inefficient. One of the important aspects of fluorescence detection is the separation of the excitation from the emission light. Since the Stokes shift is small for most fluorophores (typically 20 nm) high quality filters optical are required to discriminate the emitted light from the excitation light. In the case of strong light scattering, excitation light will be scattered in the direction of the detector which increases the leakage through the filter and hence the background level detected. For example, the far-field light transmission of a 150 micron thick porous nylon membrane with an effective pore size of 200 nm is only 0.3%, as determined in immersion in water.

Hence with known systems, a lot of light is lost and/or contributes to a background level which then reduces the signal to noise ratio. A major cause of this low efficiency is scattering of light in the porous substrates, which are used in flow-through devices. Lost light reduces the signal and stray light increases the background and in this way deteriorates the sensitivity of the biosensor. There is a need to improve the light outcoupling efficiency and consequently the sensitivity of the sensor.

An object of the present invention is to provide improved sensors, especially chemical, biochemical, or biosensors as well as methods of making and operating the same.

In one aspect, the present invention provides a flow through sensor for use with a liquid analyte solution, comprising a porous substrate, means for transporting the analyte solution to the porous substrate in a flow-through arrangement, wherein the difference in refractive index between the porous substrate and the analyte solution to be used is less than 0.15. This provides a sensor with an improved optical output. The difference in refractive index between the porous substrate and the analyte solution is preferably less than 0.08 and more preferably less that 0.03. The closer the refractive index of the substrate is matched with the one of the analyte solution, the more efficient is the sensor, e.g. having a higher sensitivity.

In another aspect of the present invention a flow through or a flow over sensor for use with a liquid analyte solution is provided, comprising a porous substrate, means for transporting the analyte solution to the porous substrate, wherein the refractive index of the porous substrate is in the range 1.24 and 1.42 or between 1.31 and 1.35. These ranges allow a matching of the refractive index of the substrate to that of aqueous analyte solutions.

In a further aspect of the present invention a sensor for use with a liquid analyte solution is provided, comprising:

a porous substrate,

means (9) for transporting the analyte solution to the porous substrate,

wherein the difference in refractive index between the porous substrate and the analyte solution is less than 0.15, the porous substrate including nanoporosity.

The porous substrate may comprise nanopores. These nanopores have preferably the shape of closed cells, and may be fulfilled with air. The average diameter size of the nanopores is preferably from 1 to 100 nm, e.g. from 10 to 90 nm. The use of nanoporosity has the advantage that the nanopores can affect the bulk refractive index without causing scattering. The filling fraction of the nanocells within the substrate can be adapted to adjust the refractive index of the substrate as they are filled with a gas such as air which has a low refractive index. Preferably, the volumetric filling ratio Vp of the nanopores is in the range of 1 to 50% of the porous substrate.

Preferably the sensor is adapted to use an analyte that is water based. The advantage is that many important applications in health and food diagnostics use targets which are in aqueous solutions.

The porous membrane can be carried by a support provided with fluidic channels. This allows a supported substrate so that its thickness can be chosen over a wider range. This allows the optical efficiency in terms of the number of light emitters in the substrate and the scattering of light to be optimized. Preferably, the support is porous and has a much larger pore size than the porous substrate. This prevents the channels in the support from impeding the flow to and from the substrate.

The substrate can be made of inorganic or organic material or combinations of both. Organic materials in the form of polymeric fibers can be manufactured easily and are light in weight. Also organic materials can have low refractive indices. Inorganic materials have the advantage of being processed very precisely, e.g. by etching or molding. Inorganic materials are more often hydrophilic than polymeric materials. For example, the porous substrate may comprise quartz, amorphous SiO₂, organically modified siloxane and combinations thereof.

The sensors of the invention may also comprise microchannels in the support required to flow the analyte solution towards and/or through the substrate. These microchannels are open and provide a connection between a liquid input conduit for the sensor and a major surface of the substrate. Typical diameter size of the channels is in the order of 50-500 nm. The microchannels of the substrate are preferably hydrophilic. This is to allow wetting with aqueous analyte solutions, which is a common application of such biosensors.

Preferably, capture probes are held, or retained, e.g. attached or immobilized on the porous substrate to which molecules—for example biomolecules—in the analyte solution are to bind.

In a preferred embodiment, the sensor is a biosensor. In a most preferred embodiment, the porous substrate is a membrane.

In another aspect, the present invention provides the use of a sensor as described before with a liquid solution, wherein the difference in refractive index between the porous substrate and the analyte solution is less than 0.15.

How the present invention may be put into effect will now be described by way of example with reference to the appended drawings, in which:

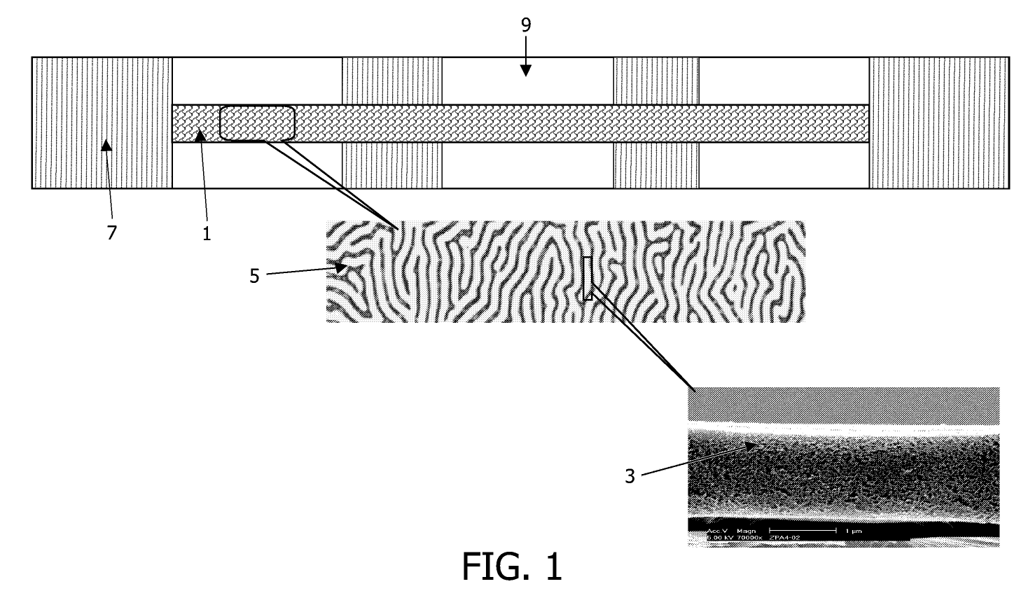

FIG. 1 shows an arrangement of a porous membrane in accordance with an embodiment of the present invention; and

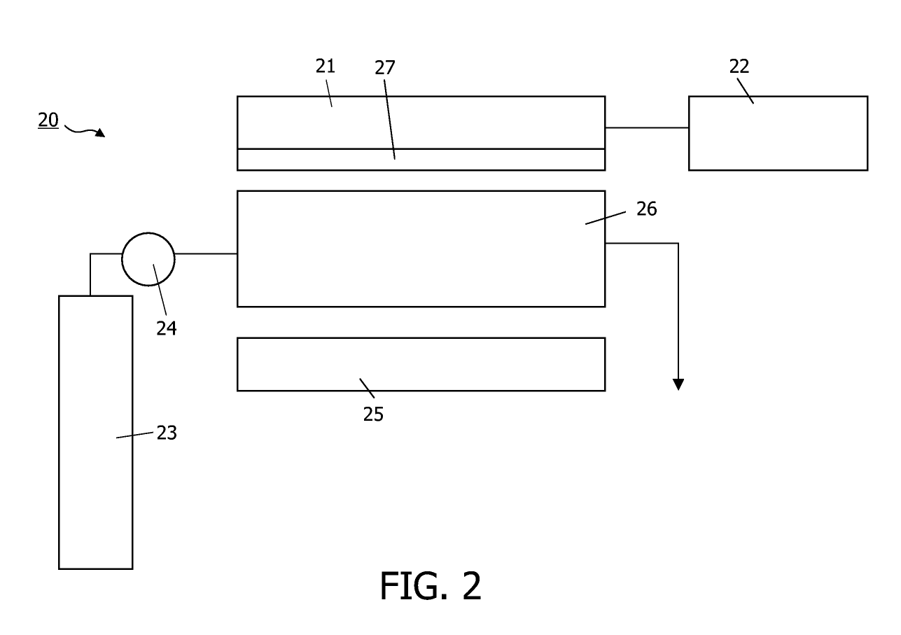

FIG. 2 shows a block diagram of a biosensor in accordance with an embodiment of the present invention.

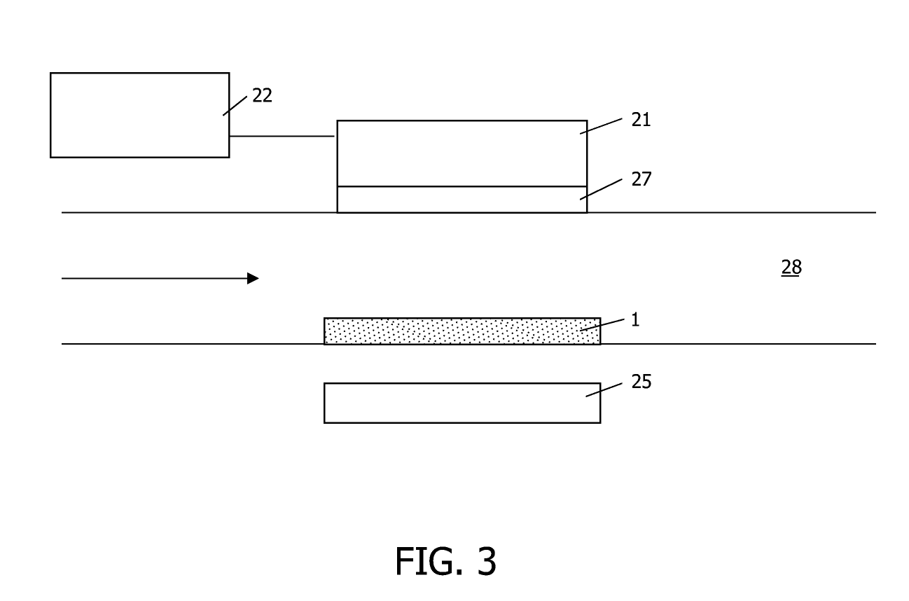

FIG. 3 shows a detail of a further embodiment of the present invention for a flow over sensor.

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The present invention relates to sensors, especially chemical, biochemical, or biosensors as well as methods of making and operating the same. The sensors of the invention may be used in particular for clinical diagnostic applications, like diagnosis of infectious diseases, as well as for monitoring food quality, environmental parameters, etc.

One aspect of the present invention is the matching of refractive index of a porous substrate with an analyte solution used with the substrate. One of the important aspects of fluorescence detection is the separation of the excitation from the emission light. Since the Stokes shift is small for most fluorophores (typically 20 nm) high quality optical filters are required to discriminate between the emitted light and the excitation light. By preventing the excitation beam from entering the optical detector, e.g. by reducing scattering of the excitation and/or emitted light, the background due to filter limitations is reduced strongly. This improves efficiency when a porous translucent substrate is used in flow-through arrangement.

In embodiments a flow-through or a flow-over biosensor is described with substrate having a special membrane structure for improved optical signal output. The translucent porous membrane has capture probes, to which biomolecules in the solution bind, that are held, retained, attached or immobilized on microchannels. The binding activates a change in luminosity or color or a light output, e.g. from a fluorophore associated with a probe. The molecules which are held, retained attached or immobilized on the porous substrate will be called light variable molecules. The sensitivity of the sensor depends among others on the efficiency of the light outcoupling from the membrane. By replacing conventional membranes with optically matched materials light, scattering is avoided. This leads to a strongly increased light output and consequently a more sensitive measurement of biological binding. Losses in both the exciting light beam as well as the emitted light are avoided or reduced. Due to the absence of scattering, the components in the light path become more efficient. The membrane is preferably dimensioned to be mechanically stable, e.g. approximately 150 micron thick, for example in the thickness range of 10 micron to 1 mm.

In a preferred embodiment, the membrane is optically matched with a water-based analyte. This reduces or eliminates light scattering and places limits on the refractive index of the membrane. The refractive index of water is 1.33. The present invention includes the use of porous membrane materials with an effective refractive index of between 1.24 and 1.42. An example of a membrane which can be used with the present invention is nanoporous quartz in the form of a porous material containing microchannels in which the biological probes are immobilized or can be held or retained, e.g. by the flow of analyte. Examples of probes related to aqueous analytes are nucleic acid probes, DNA oligos and/or antibodies, antigens, receptors, haptens, or ligands for a receptor, a protein or peptide, a lipid, a fatty acid, a carbohydrate, a hydrocarbon, a cofactor, a redox reagent, an acid, a base, a cellular fraction, a subcellular fraction, a viral or bacterial or protozoal sample, a fragment of a virus, a bacteria or a protozoa. The refractive index of the porous membrane can be tuned by selecting or altering the density of the nanoporous material, e.g. by setting the volume fraction of nanopores in the material.

The porosity for the liquid flow is on a much larger scale than the nanoporosity for adjusting the refractive index. Typically 100-1000 micrometer sized channels are formed. This can be achieved by various techniques, e.g. micromolding and/or controlled phase separation. The membrane can be carried by a further support containing micro- or macroscopic fluidic channels.

It has been found that the light yield of a flow-through or flow-over optical biosensor is dramatically improved by reducing the light scattering using an optically matched porous membrane material, especially an optically matched porous membrane material. The scattered intensity scales roughly with the square of the refractive index mismatch between the porous membrane material and the fluid flowing in and/or through the membrane, which means that even in the case of a non-perfect match the gain in light output can be useful. A mismatch of 0.15 or less, preferably 0.08 or less, preferably 0.03 or less in refractive indices at a measurement wavelength is useful in accordance with the present invention. This mismatch may also be expressed as a mismatch of 10% or less, preferably 6% or less or most preferably 2% or less in refractive index.

It is preferred if the material of the porous membrane is hydrophilic or the pores are coated with a hydrophilic substance or the pores are treated to make them hydrophilic, e.g. plasma treatment. Preferably, the refractive index of the porous membrane is between 1.24 and 1.42, more preferably between 1.31 and 1.35 for the case of an analyte solution with a refractive index of 1.33. This increases the transmission of both the exciting light beam as well as the emitted light and consequently improves the sensitivity of the measurement.

The biosensor in accordance with the present invention may be used with or include an optical detector or sensor. The optical detector can be an optical sensor, a camera such as a CCD camera or any other optical detection device including a microscope. Suitable probes which are adapted to the sensor input are included within the porous membrane. These probes may include or be attached to light emitting molecules such as fluorescent or chemiluminescent molecules (sometimes described as “fluorophores”) which emit light or change their light output when a target molecule binds to the probe. Such molecules will be described as optically variable molecules. Alternatively, the probes may include or be attached to molecules which change color or luminosity when a target molecules bind to the probes, i.e. also optically variable molecules. Any of these probes can be detected by optical detection means. In the following reference will only be made to fluorophores but the skilled person will appreciate that any of the embodiments of the invention can be used with probes which change their optical output or appearance when bound to an analyte target molecule.

The fluorophores or other optically variable molecules are held or restrained by, attached or immobilized on the surfaces of the microchannels. For instance they may be covalently attached to the inside of the microchannels in the membrane. The membrane can be incorporated in or with a further support with fluidic channels to further improve the light outcoupling to a sensor surface.

In preferred embodiments the matching of the refractive index between membrane and water is achieved by using closed-cell nanoporous materials as membrane material. In one embodiment, on the micron scale a co-continuous morphology is present, i.e. there are microchannels throughout the membrane, whereas at the nanoscale closed nanopores are present. The role of the microchannels, which are open, is to allow the flow of the analyte solution towards and/or throughout the membrane, whereas the role of the nanopores is to reduce the refractive index of the membrane material.

The membrane material may be, for instance, an organically modified siloxane. Other materials may be used. The membrane materials can be inorganic, e.g. comprising or being based on SiO₂, or organic, e.g. thermoplastic or thermosetting polymers. Amorphous SiO₂ has a refractive index of 1.46, Nylon 1.53-1.56 and Nitrocellulose 1.51, as compared to that of water of 1.33. The difference in refractive index to a dilute aqueous solution is thus between 0.13 and 0.23. If the optical transmission is to be increased by a factor of 10 to 100 the refractive index difference must be reduced by a factor of 3 to 10, i.e. to 0.06 to 0.02.

According to the invention, even materials having a high refractive index may be used provided that the porous substrate has an adapted porosity at the nanoscale to thereby reduce the refractive index.

For example, a matrix with a refractive index of 1.39 will give a significant improvement with water. A matrix with a refractive index of 1.35 would be essentially transparent, i.e. little or no scattering. A few materials are available with a refractive index below 1.4, e.g. highly fluorinated materials, like perfluorinated alkanes (Teflon AF:n=1.30).

The latter class of materials displays a strong hydrophobicity which can be a disadvantage for the pressure required for the aqueous solution to flow through the capillaries. These materials are also very limited in their ability to bind capture probes as there is little ‘chemical access’. However, by adjusting the degree of fluorination and appropriate oxygen plasma treatment sufficient reactivity can be generated at the surface to allow coupling of binding layers, which in their turn can bind biological capture probes, like DNA oligomers and antibodies.

An alternative material for the membrane is quartz or fused silica. Such materials are well known for their strong binding of DNA. Fused silica has a refractive index of 1.46 (at a wavelength of 550 nm) which only provides a limited optical performance. The material can be synthesised from the liquid state in so-called sol-gel processing. Along this route a controlled porosity can be introduced at the nano scale.

In the case that the pore size is of the order of, or below the wavelength of the light, no scattering will occur. When the morphology of the pores is that of closed cells, water will not penetrate therein, so that the refractive index n will scale with the volumetric filling ratio vₚ as given by:

n=1.46(1−vₚ)+1 vₚ

for n=1.33 vₚ=0.28,

where vₚ is the volume fraction of air-filled ores. For example, a porosity of 28% would give a perfect optical match In a further embodiment of the present invention a low refractive index membrane can be produced by a sol-gel process, for example:

TMOS, TetraMethoxyOrthoSilicate moles 1

MTMS, MethylTriMethoxySilicate moles 1

Water 1, with formic acid (1M acid) moles 7

Water 2 moles 11

n-propanol

CTAB, hexamethyl trimethyl ammoniumbromide, moles 0.2 or 0.3 (Si:CTAB 1:0.1 and 1:0.15) ionic surfactant

The membrane is prepared in the following way:

Add TMOS, MTMS and acid water 1 and let hydrolyse for 30 minutes. Add n-propanol to dilute solution to desired concentration of about 10-20 wt % SiO₂. Add water 2 and add CTAB, 0.2 or 0.3 moles.

Let solution age at room temperature for a night. Then store in freezer.

The resulting solution can be applied by spin coating on a carrier, at the following conditions: dosing at 100 RPM, leveling at 1000 RPM, drying at 300 RPM. After spinning further drying at 50° C. Curing is done in air at 400° C. for 15 minutes.

The coatings prepared in the above described way have a porosity between 50 and 55 vol %. The index of refraction n is between 1.2 and 1.25 over a broad wavelength range. Accordingly, a porosity of 28% can be achieved by using the appropriate CTAB concentration. In order to use the sol-gel solution to, for example, infiltrate a (micro channel) porous polymer membrane, the concentration can be increased. Vacuum distillation of the hydrolysis mixture to a solid content of about 80 wt % is then a preferred way. After infiltration the polymer can be washed away and the sol-gel matrix cured at 300-400° C. to obtain the nanoporous silica network.

Combinations of low refractive index polymers and nanoporous silica can be used to improve the mechanical properties of otherwise fragile silica without sacrificing the optical transparency and profiting from the attractive surface properties of silica.

As well as the nanostructure of the membrane material of the kind described above, a microstructure is required in silica for instance in order to be able to use the material as a flow-through template for the desired biological binding. Microstructures, such as for instance, microchannels, can be achieved in various ways, e.g. by phase separation, lithography, assembly of fibres or micro-molding (-casting) and combinations of these, depending on the required flow resistance (pressure drop) and specific surface of the membrane. Such low index membranes are known to the skilled person and a few examples of manufacturing routes are mentioned below.

In the case of molding, a microstructured open mold is filled with a polymer solution, which is then allowed to dry. During that process the layer shrinks until the thickness is less than the height of the microstructures of the mold so that openings are created in the layer (Laura Vogelaar, Rob G. H. Lammertink, Jonathan N. Barsema, Wietze Nijdam, Lydia A. M. Bolhuis-Versteeg, Cees J. M. van Rijn, Matthias Wessling, Small, Volume 1, Issue 6, Date: June 2005, Pages: 645-655). The microstructures can be of the required micronsize directly if an appropriate mold is used. Such a mold can be manufactured by replication from an etched silicon master.

This process can be adjusted such that phase separation occurs during drying so that in the layer between the microstructures a co-continuous 2-phase system is created. After release from the mold one of the two components is removed, either by evaporation or selective dissolution in an appropriate solvent.

It can also be sufficient to make a continuous layer of such a phase-separated material (i.e. without using a microstructured mold) by a casting, printing or other coating process on a temporary substrate, for example in a reel-to-reel process.

After having produced the porous membrane layer, the latter can be packed between structured elements with channel structures of a much larger dimension than the pores of the membrane in order to support the membrane mechanically and/or supply guidance for the liquid or the light through the membrane

In FIG. 1, the nanosize porosity of a porous membrane 1 is obtained by nanopores 3 having the shape of closed cells, as can be seen in the electronic microscopy image at the bottom right side of the Figure. The middle part illustrates open microchannels 5, on which capture probes (not represented) may be attached. These microchannels have a microsize porosity. The membrane is surrounded by a mechanical support, namely a support 7, which comprises fluidic channels 9 of millisize porosity. An alternative manufacturing technique is that of spinning fibers of a material such as fluorinated polymers. Optionally a nanoporous silica cladding may be applied. A felt or mat can be produced from these fibers which can be packed or sintered to make them coherent. Such a fiber mat can then be packed in a mechanical support. The pore size is determined by the fiber diameter and the packing pressure.

Assays in which a biosensor according to the present invention can be used may include sequencing by hybridisation, immunoassays, receptor/ligand assays and the like.

A biosensor arrangement 20 is shown schematically in FIG. 2 for a transmissive flow through membrane 26 in accordance with the present invention. A reflective arrangement is also included within the scope of the present invention. A source of analyte 23 is fed to the membrane 26 via a pump 24 or gravity or capillary feed. The analyte will typically contain biomolecules or chemical entities to be detected by the biosensor. Optionally, a source of radiation 25, e.g. light, is located adjacent to the membrane 26 to illuminate it. Ambient lighting conditions may also be used to illuminate the membrane 26. An optical detector 21 is located on one side of the membrane to record light output or color changes. The optical detector can be an optical sensor or an array of such sensors or can be camera such as a CCD camera. The optical detector may have an optical filter 27 to attenuate light from the light source 25 and to allow transmission of light emitted from light variable molecules such as chemiluminescent or fluorescent probes in the membrane 26. Output electronics 22 are connected to the detector 21 by a wire, an optical fiber, or a wireless connection or any other suitable communications connection to process the output of the detector 21 and to provide a display output, alarms, hardcopy output, etc. as required.

In other embodiments of the present invention, the optical matching of the substrate with the fluid is also beneficial in flow-over devices with solid substrates. Optical modes which travel in the substrate and are not coupled out due to the transition to a less dense medium are avoided in this manner. The light which is generated right at the interface will not experience the interface optically and consequently will be transmitted isotropically, so that it can easily be directed towards the sensor surface by geometrical optics. Unstructured nanoporous silica can be used as substrate for flow-over biosensor devices with optical detection. In FIG. 3, the nanosize porosity of a porous membrane 26 as used in a transmissive flow-over sensor is also obtained by nanopores having the shape of closed cells. Any of the nanoporous materials described with reference to the previous embodiments may be used in this embodiment. In particular the refractive index difference between the porous substrate and the analyte solution to be used is preferably less than 0.15. The difference in refractive index between the porous substrate and the analyte solution is preferably less than 0.08 and more preferably less that 0.03. The closer the refractive index of the substrate is matched with the one of the analyte solution, the more efficient is the sensor, e.g. having a higher sensitivity. The refractive index of the porous substrate can be in the range 1.24 and 1.42 or between 1.31 and 1.35. These ranges allow a matching of the refractive index of the substrate to that of aqueous analyte solutions.

The membrane 26 is located in a conduit 28. A source of analyte is fed to the membrane 26 via a pump or gravity or capillary feed. The analyte will typically contain biomolecules or chemical entities to be detected by the sensor. Optionally, a source of radiation 25, e.g. light, is located adjacent to the conduit 28 to illuminate the membrane 26. Ambient lighting conditions may also be used to illuminate the membrane 26. An optical detector 21 is located on one side of the conduit to record light output or color changes. The optical detector can be an optical sensor or an array of such sensors or can be camera such as a CCD camera. The optical detector may have an optical filter 27 to attenuate light from the light source 25 and to allow transmission of light emitted from light variable molecules such as chemiluminescent or fluorescent probes in the membrane 26. As described with reference to FIG. 2 output electronics 22 can be connected to the detector 21 by a wire, an optical fiber, or a wireless connection or any other suitable communications connection to process the output of the detector 21 and to provide a display output, alarms, hardcopy output, etc. as required.

Both reflective and transmissive biosensors can be used in accordance with the present invention. For sensitivity of the arrangement the effective collection angle of the emitted radiation is important. The optical detector can be immersed in the analyte solution to avoid internal reflections.

Excitation intensities of the light source are related to the type of source and the field of illumination. For example, 0.1-1 W light sources can be used and can be any suitable type, e.g. LED, laser, etc. Preferably, the light sources should be selected to excite the fluorophores to about half of the saturation intensity. The exposure time should be short to avoid photobleaching of the fluorophores. Hence pulsed light sources are preferred.

The biosensor arrangement of FIG. 2 or 3 may be integrated in a microfluidic device whereby the analyte flow may be driven by gravity feed, capillary action or by a microfluidic pump. The present invention also relates to a kit comprising any of the above mentioned biosensors. Such a kit may additionally comprise a detection means for determining whether binding has occurred between the probes and the analyte. Preferably, such detection means may be a substance which binds to the biomolecules in the analyte provided with a label. Preferably, the label is capable of inducing a color reaction and or capable of bio- or chemo- or photoluminescence or fluorescence.

When a biosensor according to the present invention is used to obtain nucleic acid sequence information, a large array of target areas is provided on the membrane, each area including as a binding substance a DNA oligo probe of a different base-pair sequence. If a sample containing DNA or RNA fragments with a (partly) unknown sequence is brought into contact with the membrane a specific hybridisation pattern occurs, from which pattern the sequence of the DNA/RNA can be derived.

A biosensor according to the present invention may also be used to screen a biological specimen, such as blood, for any of a number of analytes. The array may consist of areas comprising DNA oligo probes specific for, for example, pathogens such as bacterial pathogens. If a blood sample is brought into contact with the device, the resulting hybridisation pattern can be read by the optical detector from which the presence of the bacteria can be inferred. A biosensor according to the present invention is suitable for the detection of viruses. In method is to detect single point mutations in the virus RNA.

A biosensor according to the present invention is also suited for performing sandwich immunoassays. In a sandwich assay a second ligand such as an antibody is used for binding to bound analyte. The second ligand is preferably recognisable, e.g. by use of a specific antibody. Other arrangements for accomplishing the objectives of the invention and embodying the invention will be obvious for those skilled in the art.

It is to be understood that although preferred embodiments, specific constructions and configurations, as well as materials, have been discussed herein for devices according to the present invention, various changes or modifications in form and detail may be made without departing from the scope and spirit of this invention.

1. A flow-through sensor for use with a liquid analyte solution, comprising:
a porous substrate (1),
means (9) for transporting the analyte solution to the porous substrate (1) in a flow-through arrangement,
wherein the difference in refractive index between the porous substrate (1) and the analyte solution is less than 0.15.

2. A sensor for use with a liquid analyte solution, comprising:
a porous substrate (1),
means (9) for transporting the analyte solution to the porous substrate (1),
wherein the difference in refractive index between the porous substrate (1) and the analyte solution is less than 0.15, the porous substrate including nanoporosity.

3. A sensor for use with a liquid analyte solution, comprising:
a porous substrate (1),
means (9) for transporting the analyte solution to the porous substrate (1), wherein the refractive index of porous substrate (1) is in the range from 1.24 to 1.42.

4. The sensor according to claim 1, wherein the difference in refractive index between the porous substrate (1) and the analyte solution is less than 0.08.

5. The sensor according to claim 4, wherein the difference in refractive index between the porous substrate (1) and the analyte solution is less than 0.03.

6. The sensor according to claim 1, wherein the material for the porous substrate (1) is chosen from the group consisting of inorganic materials, organic materials and mixtures thereof.

7. The sensor according to claim 1, wherein the porous substrate (1) comprises compounds chosen form the group consisting in quartz, amorphous SiO2, and organically modified siloxane and mixtures thereof.

8. The sensor according to claim 1, wherein the porous membrane (1) comprises nanopores (3).

9. The sensor according to claim 8, wherein the nanopores (3) have the shape of closed cells.

10. The sensor according to claim 9, wherein the nanopores (3) are filled with air.

11. The sensor according to claim 10, wherein the volumetric filling ratio Vp of the nanopores (3) is in the range of 1 to 50% of the volume of the porous substrate (1).

12. The sensor according to claim 11, wherein the average diameter size of the nanopores (3) is significantly lower than the wavelength of the light used for optical analysis.

13. The sensor according to claim 12, wherein the average diameter size of the nanopores (3) is less than 50 nm.

14. The sensor according to claim 1, wherein the analyte is water based.

15. The sensor according to claim 1, wherein the porous substrate (1) is self-supporting.

16. The sensor according to claim 1, wherein the porous substrate (1) is supported by a support (7) provided with at least one fluidicchannel (9) for delivering the analyte solution to the porous membrane (1).

17. The biosensor according to claim 1, wherein the porous substrate (1) comprises microchannels (5).

18. The sensor according to claim 14, wherein the average diameter size of the microchannels (5) is less than 5 μm.

19. The sensor according to claim 17, wherein the microchannels (5) of the porous substrate (1) are hydrophilic or are coated with a hydrophilic material.

20. The sensor according to claim 1, wherein capture probes are immobilized on the porous substrate (1) to which molecules in the analyte solution are to bind.

21. The sensor according to claim 1, which is a biosensor.

22. The sensor according to claim 1, wherein the porous substrate (1) is a membrane.

23. Use of a sensor according to claim 1, with a liquid analyte wherein the difference in refractive index between the porous substrate (1) and the analyte solution is less than 0.15.
